(19) United States
(12) Patent Application Publication
(10) Pub. No.: US 2019/0033580 A1
(43) Pub. Date: Jan. 31, 2019

(54) OPTICAL COMPENSATION STRUCTURE

(71) Applicants: Industrial Technology Research Institute, Hsinchu (TW); Intellectual Property Innovation Corporation, Hsinchu (TW)

(72) Inventors: Chih-Chia Chang, Hsinchu County (TW); Kai-Ming Chang, New Taipei City (TW); Chun-Ko Chen, Kaohsiung City (TW)

(73) Assignees: Industrial Technology Research Institute, Hsinchu (TW); Intellectual Property Innovation Corporation, Hsinchu (TW)

(21) Appl. No.: 15/710,834

(22) Filed: Sep. 21, 2017

(30) Foreign Application Priority Data
Jul. 26, 2017 (TW) 106125139

(51) Int. Cl. G02B 27/00; B32B 7/12

(52) U.S. Cl. CPC G02B 27/0025; B32B 2307/418; B32B 7/12

(57) ABSTRACT

An optical compensation structure including a substrate, a barrier layer, and a first coating layer is provided. The barrier layer is deposed on the substrate. The barrier layer has a first refractive region and a second refractive region adjacent thereto. A refractive index of the second refraction region is greater than a refractive index of the first refractive region. The first coating layer covers a portion of the second refractive region.

### CROSS-REFERENCE TO RELATED APPLICATION

This application claims the priority benefit of Taiwan application serial no. 106125139, filed on Jul. 26, 2017. The entirety of the above-mentioned patent application is hereby incorporated by reference herein and made a part of this specification.

### TECHNICAL FIELD

The disclosure relates to an optical structure and further relates to an optical compensation structure.

### BACKGROUND

Following the advanced development of electronic technologies, electronic products are evolving rapidly. To apply the electronic products in different fields, the characteristics of being flexible, light, thin and having no limitation on shape are drawing more and more attention. Namely, there is a requirement on the shape of the electronic products to be various based on different purposes and environments of application.

Generally, substrates, coating layers and/or adhesive layers in an electronic product are patterned, such that the electronic produce can be flexed, curved or folded. However, an optical disparity issue may occur to the patterned substrates, coating layers and/or adhesive layers, when being in use, which may lead to a poor visual effect of the electronic product. Therefore, how to mitigate the optical disparity issue occurring to the patterned substrates, coating layers and/or adhesive layers to improve the visual effect has become an important subject.

### SUMMARY

According to an embodiment of the disclosure, an optical compensation structure capable of improving the optical disparity issue is introduced herein.

According to an embodiment of the disclosure, an optical compensation structure including a substrate, a barrier layer and a first coating layer is provided. The barrier layer is located on the substrate. The barrier layer has a first refractive region and a second refractive region adjacent to the first refractive region. A refractive index of the second refractive region is greater than a refractive index of the first refractive region. The first coating layer covers a portion of the second refractive region.

According to an embodiment of the disclosure, an optical compensation structure including a substrate, a barrier layer, a first coating layer and a second coating layer is provided. The barrier layer is located on the substrate. The barrier layer has a first refractive region and a second refractive region adjacent to the first refractive region. A refractive index of the second refractive region is greater than a refractive index of the first refractive region. The first coating layer has a first coating part and a second coating part adjacent to the first coating part. The first coating part covers a region other than the second refractive region. The second coating part covers the second refractive region. A thickness of the first coating part is greater than a thickness of the second coating part. The second coating layer is located between the first coating layer and the barrier layer. The second coating layer contacts the barrier layer.

According to an embodiment of the disclosure, an optical compensation structure including a substrate, a barrier layer, a first adhesive layer and a second adhesive layer is provided. The barrier layer has a first refractive region and a second refractive region adjacent to the first refractive region. A refractive index of the second refractive region is greater than a refractive index of the first refractive region. The first adhesive layer is located between the barrier layer and the substrate. The second refractive region is distributed corresponding to the first adhesive layer. The second adhesive layer is located between the barrier layer and the substrate. The first adhesive layer does not overlap the second adhesive layer.

Based on the above, the embodiments of the disclosure can contribute to providing optical compensation to the patterned substrates, coating layers and/or adhesive layers, so as to improve the optical disparity issue.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view of an optical compensation structure according to a first embodiment of the disclosure.

FIG. 2 is a schematic cross-sectional view of an optical compensation structure according to a second embodiment of the disclosure.

FIG. 3 is a schematic cross-sectional view of an optical compensation structure according to a third embodiment of the disclosure.

FIG. 4 is a schematic cross-sectional view of an optical compensation structure according to a fourth embodiment of the disclosure.

FIG. 5 is a schematic cross-sectional view of an optical compensation structure according to a fifth embodiment of the disclosure.

FIG. 6 is a schematic cross-sectional view of an optical compensation structure according to a sixth embodiment of the disclosure.

FIG. 7 is a schematic cross-sectional view of an optical compensation structure according to a seventh embodiment of the disclosure.

FIG. 8 is a schematic cross-sectional view of an optical compensation structure according to an eighth embodiment of the disclosure.

FIG. 9 is a schematic cross-sectional view of an optical compensation structure according to a ninth embodiment of the disclosure.

FIG. 10 is a schematic cross-sectional view of an optical compensation structure according to a tenth embodiment of the disclosure.

FIG. 11 is a schematic cross-sectional view of an optical compensation structure according to an eleventh embodiment of the disclosure.

FIG. 12 is a schematic cross-sectional view of an optical compensation structure according to a twelfth embodiment of the disclosure.

FIG. 13 is a schematic cross-sectional view of an optical compensation structure according to a thirteenth embodiment of the disclosure.

FIG. 14 is a schematic cross-sectional view of an optical compensation structure according to a fourteenth embodiment of the disclosure.

FIG. 15 is a schematic cross-sectional view of an optical compensation structure according to a fifteenth embodiment of the disclosure.

FIG. 16 is a schematic cross-sectional view of an optical compensation structure according to a sixteenth embodiment of the disclosure.

FIG. 17 is a schematic cross-sectional view of an optical compensation structure according to a seventeenth embodiment of the disclosure.

FIG. 18 is a schematic cross-sectional view of an optical compensation structure according to an eighteenth embodiment of the disclosure.

FIG. 19 is a schematic cross-sectional view of an optical compensation structure according to a nineteenth embodiment of the disclosure.

FIG. 20 is a schematic cross-sectional view of an optical compensation structure according to a twentieth embodiment of the disclosure.

FIG. 21 is a schematic cross-sectional view of an optical compensation structure according to a twenty-first embodiment of the disclosure.

FIG. 22 is a schematic cross-sectional view of an optical compensation structure according to a twenty-second embodiment of the disclosure.

FIG. 23 is a schematic cross-sectional view of an optical compensation structure according to a twenty-third embodiment of the disclosure.

FIG. 24 is a schematic cross-sectional view of an optical compensation structure according to a twenty-fourth embodiment of the disclosure.

FIG. 25 is a schematic cross-sectional view of an optical compensation structure according to a twenty-fifth embodiment of the disclosure.

FIG. 26 is a schematic cross-sectional view of an optical compensation structure according to a twenty-sixth embodiment of the disclosure.

### DETAILED DESCRIPTION OF DISCLOSED EMBODIMENTS

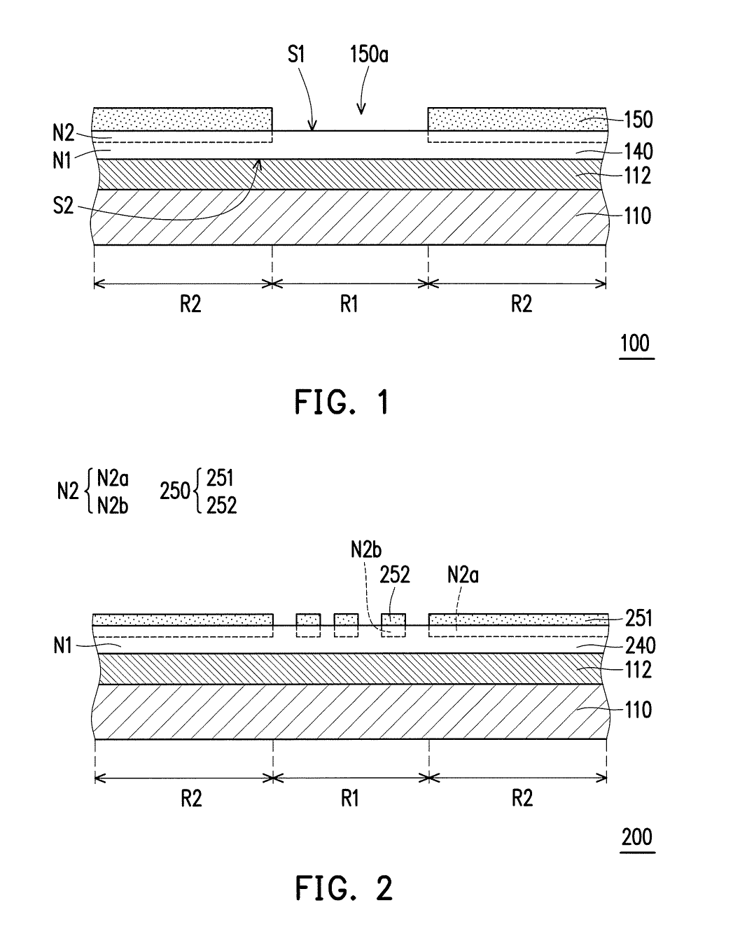

FIG. 1 is a schematic cross-sectional view of an optical compensation structure according to a first embodiment of the disclosure. With reference to FIG. 1, an optical compensation structure 100 of the present embodiment includes a substrate 110, a barrier layer 140 and a first coating layer 150. The barrier layer 140 is located on the substrate 110. The barrier layer 140 has a first refractive region N1 and second refractive regions N2 adjacent thereto. A refractive index of the second refractive regions N2 is greater than a refractive index of the first refractive region N1. The first coating layer 150 is disposed corresponding to the second refractive regions N2 of the barrier layer 140, and the first coating layer 150 covers the second refractive regions N2 of the barrier layer 140.

In the present embodiment, the optical compensation structure 100 may further includes an electronic component layer 112. The electronic component layer 112 is located between the barrier layer 140 and the substrate 110. The electronic component layer 112 may include a display component, a touch component, a sensing component, a micro-electro-mechanical component or a combination of the aforementioned components, but the disclosure is not limited thereto.

In the present embodiment, the substrate 110 is, for example, a flexible substrate. Thus, the substrate 110 is capable of being flexed or bent. A material of the substrate 110 may include, for example, polyimide (PI), polycarbonate (PC), polyamide (PA), polyethylene terephthalate (PET), polyethylene naphthalate (PEN), polyethylenimine (PEI), polyurethane (PU), polydimethylsiloxane (PDMS, an acrylate (e.g., polymethylmethacrylate (PMMA)), an ether polymer (e.g., polyethersulfone (PES) or polyetheretherketone (PEEK)), polyolefin or other flexible materials, but the disclosure is not limited thereto.

The barrier layer 140 has a first surface S1 and a second surface S2 which are opposite to each other. The barrier layer 140 covers the electronic component layer 112, and the second surface S2 of the barrier layer 140 contacts the electronic component layer 112. Generally, the barrier layer 140 may block permeation of oxygen and/or water vapor to prevent oxygen and/or water vapor in the air from damaging the electronic component layer 112 and/or other film layers under the barrier layer 140. For instance, a solution containing a silicon compound may be used and applied on the substrate 110 by a coating process to form the light-transmissive and flexible barrier layer 140. The aforementioned silicon compound includes compositions, such as polysilazane, polyorganosiloxane, polysilane, polycarbosilane or a combination thereof, but the disclosure is not limited thereto. In some embodiments, a thickness of the barrier layer 140 ranges between 1 nanometer (nm) and 1 micrometer (μm), but the disclosure is not limited thereto.

An optical property and/or constituent components of the material of the barrier layer 140, after being further chemically or physically processed, is changed. Generally, with a patterned mask, a surface treatment process may be performed on a portion of the first surface S1 of the barrier layer 140 to form the first refractive region N1 and the second refractive regions N2 which have difference refractive indices from each other on the first surface S1 of the barrier layer 140. For instance, the barrier layer 140 may be formed of a polysilazane compound, and a plasma treatment process may be performed on a portion of the first surface S1 of the barrier layer 140 by using oxygen, nitrogen, helium, argon, neon and/or krypton as a carrier gas, thereby forming the second refractive regions N2, while the other portion of the barrier layer 140 where a plasma immersion ion implantation (PIII) is not performed is the first refractive region N1. In comparison with the first refractive region N1 where the PIII process is not performed, the second refractive regions N2 formed by performing the PIII process has a greater proportion of nitrogen atomic concentration (which is also referred to as nitrogen-rich), and the refractive index of the second refractive regions N2 is greater than the refractive index of the first refractive region N1. Generally, the refractive index or depth of the second refractive regions N2 may be adjusted by adjusting different process recipes (e.g., an implantation time, a carrier gas type, a carrier gas flow, a carrier gas pressure and/or a voltage pulse) of the PIII process.

In some embodiments, the refractive index of the first refractive region N1 ranges between 1.4 and 1.95, and a difference between the refractive index of the second refractive regions N2 and the refractive index of the first refractive region N1 is at least greater than 0.01, but the disclosure is not limited thereto.

In the present embodiment, the second refractive regions N2 extend inward from the first surface S1, and the second surface S2 and a portion of the first surface S1 belong to the first refractive region N1, but the disclosure is not limited thereto. In other embodiments, the second refractive regions N2 may be embedded in the first refractive region N1 by performing a coating process and/or a surface treatment process for several times.

In the present embodiment, the first coating layer 150 contacts a portion of the first surface S1 located on the second refractive regions N2 of the barrier layer 140, but the disclosure is not limited thereto. Generally, the first coating layer 150 is a hard coating layer formed of, for example, an adhesive after being coated by means of photo-curing or thermal curing, but the disclosure is not limited thereto. A material of the adhesive is, for example, an acrylic resin or an epoxy resin, but the disclosure is not limited thereto. In some embodiments, a hardness of the first coating layer 150 is, for example, 1H pencil hardness to prevent the electronic component layer 112 and/or other film layers located under the first coating layer 150 from being worn or hit. In some embodiments, a thickness of the first coating layer 150 ranges between 1 μm and 30 μm, but the disclosure is not limited thereto.

In the present embodiment, the first coating layer 150 may be a patterned film layer having a coating opening 150a, and the coating opening 150a may be a linear, bent or curved trench or slit, such that the substrate 110 and the barrier layer 140 of the optical compensation structure 100 may be stretched, compressed or curved as the corresponding coating opening 150a is deformed. In other words, the substrate 110 of the optical compensation structure 100 has second regions R2 and a first region R1 adjacent thereto, and the coating opening 150a corresponds to the first region R1. By being compared with the second regions R2, the first region R1 may be a flexible region with a greater flexibility. Namely, the flexibility of the first region R1 is greater than a flexibility of the second regions R2. A flexible property of the first region R1 of the substrate 110 allows a horizontal and/or a vertical spacing of each second region R2 around the first region R1 to be variable. For instance, the first region R1 may be extended or compressed when an external force is received by the optical compensation structure 100, such that the optical compensation structure 100 has a corresponding deformed state. In the optical compensation structure 100 illustrated in FIG. 1, only one coating opening 150a is exemplarily illustrated, but the number of the coating opening 150a is not limited in the disclosure.

In the present embodiment, the second refractive regions N2 of the barrier layer 140 are disposed over the second regions R2 of the substrate 110, and the first coating layer 150 disposed corresponding to the second refractive regions N2 is located over the second regions R2 of the substrate 110, but the disclosure is not limited thereto.

In the present embodiment, a refractive index of the first coating layer 150 is greater than the refractive index of the first refractive region N1 of the barrier layer 140, and the refractive index of the first coating layer 150 is less than the refractive index of the second refractive regions N2 of the barrier layer 140. In this way, with the barrier layer 140 having the first refractive region N1 and the second refractive regions N2, the optical disparity issue may be prevented from occurring to the patterned first coating layer 150.

FIG. 2 is a schematic cross-sectional view of an optical compensation structure according to a second embodiment of the disclosure. An optical compensation structure 200 of the second embodiment is similar to the optical compensation structure 100 illustrated in FIG. 1, and description related to the optical compensation structure 200 will be set forth with reference to FIG. 2 in the present embodiment. It should be noted that in FIG. 2, the same or similar reference numbers are used to represent the same or similar elements, and thus, the elements which have been described with reference to FIG. 1 will not be repeated.

With reference to FIG. 2, the optical compensation structure 200 of the second embodiment is similar to the optical compensation structure 100 illustrated in FIG. 1, and the difference therebetween lies in that the second refractive regions N2 of a barrier layer 240 have first refraction parts N2a and second refraction parts N2b which are separated from each other. The first refraction parts N2a are disposed on the second regions R2 of the substrate 110, and the second refraction parts N2b are disposed on the first region R1 of the substrate 110. A first coating layer 250 has first coating parts 251 and second coating parts 252 which are separated from each other. The first coating parts 251 are disposed corresponding to the first refraction parts N2a and disposed on the second regions R2 of the substrate 110. The second coating parts 252 are disposed corresponding to the second refraction parts N2b, and disposed on the first region R1 of the substrate 110. For instance, the second coating parts 252 disposed on the first region R1 may be a plurality of bar structures or island structures which are separated from one another. In this way, the first region R1 may be correspondingly extended or compressed when an external force is received by the optical compensation structure 200, such that the optical compensation structure 200 has a corresponding deformed state.

In the present embodiment, a material and/or a forming method of the material barrier layer 240 may be similar to the material and/or the forming method of the barrier layer 140 of the embodiment above, a material and/or a forming method of the first coating layer 250 may be similar to the material and/or the forming method of the first coating layer 150 of the embodiment above and thus, will not be repeatedly described.

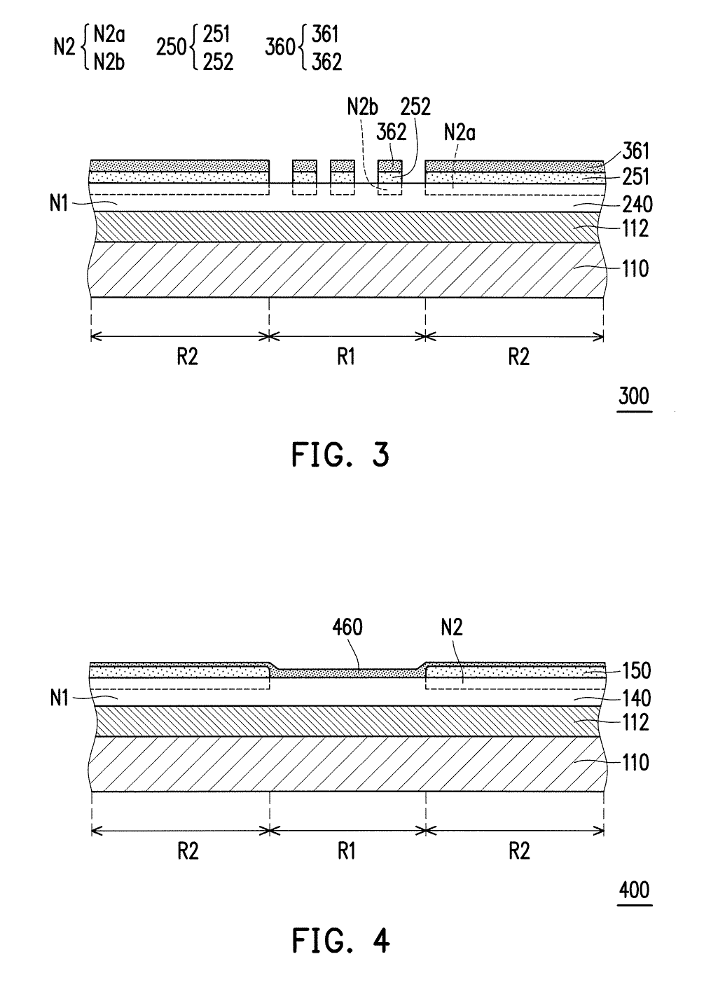

FIG. 3 is a schematic cross-sectional view of an optical compensation structure according to a third embodiment of the disclosure. An optical compensation structure 300 of the third embodiment is similar to the optical compensation structure 200 illustrated in FIG. 2, and description related to the optical compensation structure 300 will be set forth with reference to FIG. 3 in the present embodiment. It should be noted that in FIG. 3, the same or similar reference numbers are used to represent the same or similar elements, and thus, the elements which have been described with reference to FIG. 2 will not be repeated.

With reference to FIG. 3, the optical compensation structure 300 of the third embodiment is similar to the optical compensation structure 200 illustrated in FIG. 2, and the difference therebetween lies in that the optical compensation structure 300 may further include a second coating layer 360, wherein the first coating layer 250 is located between the second coating layer 360 and the barrier layer 240, and the second coating layer 360 contacts the first coating layer 250. The second coating layer 360 has third coating parts 361 and fourth coating parts 362 which are separated from each other. The third coating parts 361 are disposed corresponding to the first coating parts 251 and disposed on the second regions R2 of the substrate 110. The fourth coating parts 362 are disposed corresponding to the second coating parts 252 and disposed on the first region R1 of the substrate 110. For instance, the fourth coating parts 362 disposed on the first region R1 may be a plurality of bar structures or island structures which are separated from one another. In this way, the first region R1 may be correspondingly extended or compressed when an external force is received by the optical compensation structure 300, such that the optical compensation structure 300 has a corresponding deformed state. In brief, in the present embodiment, the second coating layer 360 is disposed corresponding to the first coating layer 250, but the disclosure is not limited thereto.

In the present embodiment, a material and/or a forming method of the second coating layer 360 may be similar to the material and/or the forming method of the first coating layer 250 and thus, will not be repeatedly described. In addition, by adjusting the material compositions and/or the forming methods of the second coating layer 360 and the first coating layer 250, the second coating layer 360 and the first coating layer 250 may be different in hardness, refractive index and/or thicknesses.

FIG. 4 is a schematic cross-sectional view of an optical compensation structure according to a fourth embodiment of the disclosure. An optical compensation structure 400 of the fourth embodiment is similar to the optical compensation structure 100 illustrated in FIG. 1, and description related to the optical compensation structure 400 will be set forth with reference to FIG. 4 in the present embodiment. It should be noted that in FIG. 4, the same or similar reference numbers are used to represent the same or similar elements, and thus, the elements which have been described with reference to FIG. 1 will not be repeated.

With reference to FIG. 4, the optical compensation structure 400 of the fourth embodiment is similar to the optical compensation structure 100 illustrated in FIG. 1, and the difference therebetween lies in that the optical compensation structure 400 may further include a second coating layer 460, wherein the first coating layer 150 is located between the second coating layer 460 and the barrier layer 140, and the second coating layer 460 contacts the first coating layer 150 and a portion of the barrier layer 140 which is not covered by the first coating layer 150. In the present embodiment, a hardness of the second coating layer 460 is greater than a hardness of the barrier layer 140, so as to prevent the portion of the barrier layer 140 which is not covered by the first coating layer 150 and/or other film layers from being worn or hit.

In the present embodiment, an etching process, a polishing process or any other similar corner rounding process may be performed on the first coating layer 150, such that the contact surfaces between the first coating layer 150 and the second coating layer 460 is rounded, but the disclosure is not limited thereto.

In the present embodiment, the second coating layer 460 covering and contacting the first coating layer 150 may be conformally disposed with the first coating layer 150 (which is also referred to as conformal coating). In this way, the top surface of the second coating layer 460 which are far away from the first coating layer 150 may also have topography corresponding to the first coating layer 150, but the disclosure is not limited thereto.

In the present embodiment, a material and/or a forming method of the second coating layer 460 may be similar to the material and/or the forming method of the first coating layer 150, and by adjusting the materials and the forming methods of the second coating layer 460 and the first coating layer 150, a thickness of the second coating layer 460 may be less than the thickness of the first coating layer 150, or the hardness of the second coating layer 460 may be less than the hardness of the first coating layer 150. In this way, the first region R1 having the second coating layer 460 may be correspondingly extended or compressed when an external force is received by the optical compensation structure 400, such that the optical compensation structure 400 has a corresponding deformed state.

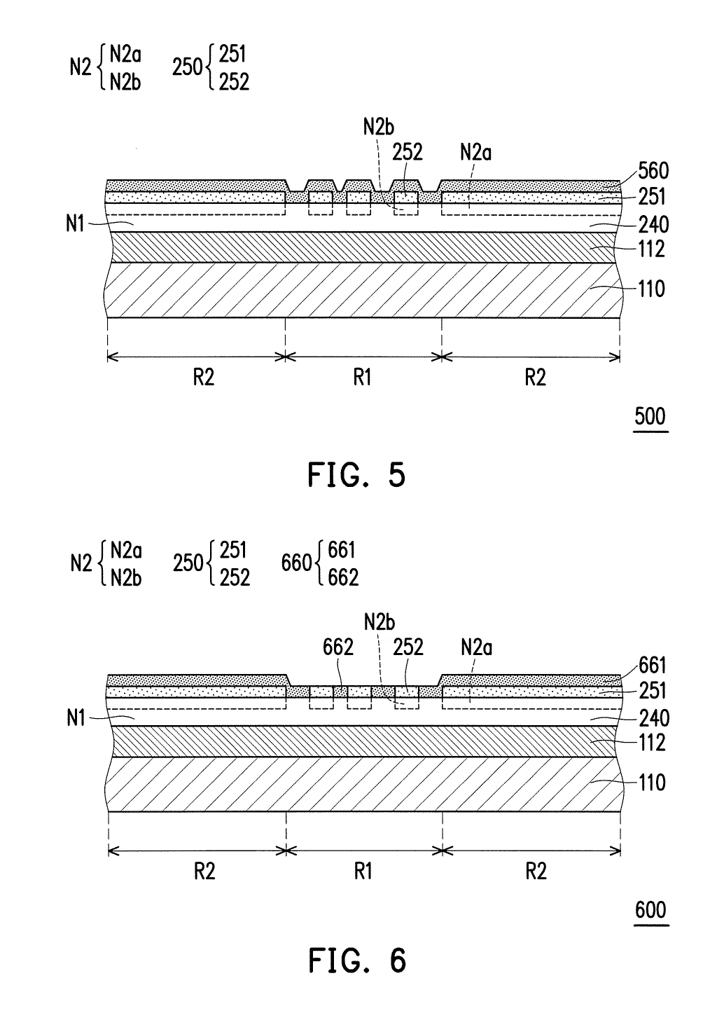

FIG. 5 is a schematic cross-sectional view of an optical compensation structure according to a fifth embodiment of the disclosure. An optical compensation structure 500 of the fifth embodiment is similar to the optical compensation structure 200 illustrated in FIG. 2, and description related to the optical compensation structure 500 will be set forth with reference to FIG. 5 in the present embodiment. It should be noted that in FIG. 5, the same or similar reference numbers are used to represent the same or similar elements, and thus, the elements which have been described with reference to FIG. 2 will not be repeated.

With reference to FIG. 5, the optical compensation structure 500 of the fifth embodiment is similar to the optical compensation structure 200 illustrated in FIG. 2, and the difference therebetween lies in that the optical compensation structure 500 may further include a second coating layer 560, wherein the first coating layer 250 is located between the second coating layer 560 and the barrier layer 240, and the second coating layer 560 contacts the first coating layer 250 and a portion of the barrier layer 240 which is not covered by the first coating layer 250. In the present embodiment, a hardness of the second coating layer 560 is greater than a hardness of the barrier layer 240 to prevent the portion of the barrier layer 240 which is not covered by the first coating layer 250 and/or other film layers from being worn or hit.

In the present embodiment, an etching process, a polishing process or any other similar corner rounding process may be performed on the first coating layer 250, such that contact surfaces between the first coating layer 250 and the second coating layer 560 may be rounded, but the disclosure is not limited thereto.

In the present embodiment, the second coating layer 560 covering and contacting the first coating layer 250 may be conformally disposed with the first coating layer 250. In this way, surfaces of the second coating layer 560 which are far away from the first coating layer 250 may also have topography corresponding to the first coating layer 250, but the disclosure is not limited thereto.

In the present embodiment, a material and/or a forming method of the second coating layer 560 may be similar to the material and/or the forming method of the first coating layer 250, and by adjusting the material compositions and the forming methods of the second coating layer 560 and the first coating layer 250, a thickness of the second coating layer 560 may be less than a thickness of the first coating layer 250, or the hardness of the second coating layer 560 may be less than a hardness of the first coating layer 250. In this way, the first region R1 having the second coating layer 560 may be correspondingly extended or compressed when an external force is received by the optical compensation structure 500, such that the optical compensation structure 500 has a corresponding deformed state.

FIG. 6 is a schematic cross-sectional view of an optical compensation structure according to a sixth embodiment of the disclosure. An optical compensation structure 600 of the sixth embodiment is similar to the optical compensation structure 200 illustrated in FIG. 2, and description related to the optical compensation structure 600 will be set forth with reference to FIG. 6 in the present embodiment. It should be noted that in FIG. 6, the same or similar reference numbers are used to represent the same or similar elements, and thus, the elements which have been described with reference to FIG. 5 will not be repeated.

With reference to FIG. 6, the optical compensation structure 600 of the sixth embodiment is similar to the optical compensation structure 200 illustrated in FIG. 2, and the difference therebetween lies in that the optical compensation structure 600 may further include a second coating layer 660, wherein a portion of the first coating layer 250 is located between the second coating layer 660 and the barrier layer 240. The second coating layer 660 includes third coating parts 661 and fourth coating parts 662 which are separated from each other. The third coating parts 661 are disposed corresponding to the first coating parts 251, and the third coating parts 661 are disposed on the second regions R2 of the substrate 110. The fourth coating parts 662 are located between the second coating parts 252 which are separated from each other, and the fourth coating parts 662 are disposed on the first region R1 of the substrate 110. For instance, the fourth coating parts 662 disposed on the first region R1 may be a plurality of bar structures or island structures which are separated from one another, and the second coating parts 252 of the first coating layer 250 are between the separated bar structures and the island structures. In the second regions R2 of the substrate 110, the first coating parts 251 of the first coating layer 250 are located between the third coating parts 661 of the second coating layer 660 and the barrier layer 240. In the first region R1 of the substrate 110, the second coating parts 252 of the first coating layer 250 contact the barrier layer 240, and the fourth coating parts 662 of the second coating layer 660 contact the barrier layer 240.

In the present embodiment, a material and/or a forming method of the second coating layer 660 may be similar to the material and/or the forming method of the first coating layer 250 and thus, will not be repeatedly described. In addition, by adjusting the material compositions and/or the forming methods of the second coating layer 660 and the first coating layer 250, the second coating layer 660 and the first coating layer 250 may be different in hardness, refractive index and/or thickness.

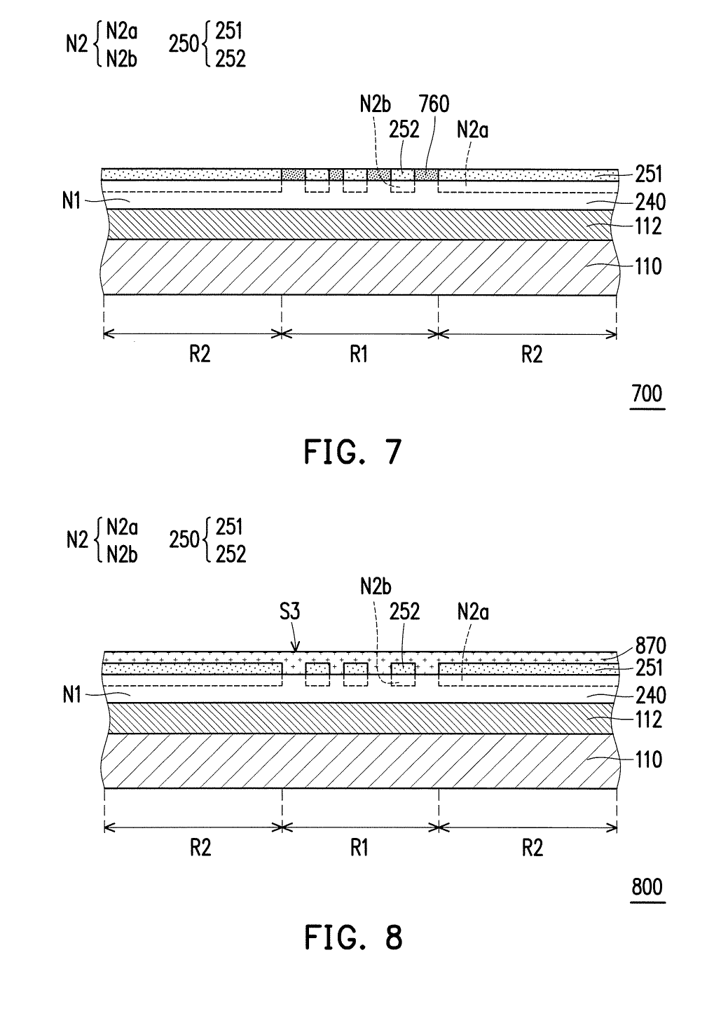

FIG. 7 is a schematic cross-sectional view of an optical compensation structure according to a seventh embodiment of the disclosure. An optical compensation structure 700 of the seventh embodiment is similar to the optical compensation structure 200 illustrated in FIG. 2, and description related to the optical compensation structure 700 will be set forth with reference to FIG. 7 in the present embodiment. It should be noted that in FIG. 7, the same or similar reference numbers are used to represent the same or similar elements, and thus, the elements which have been described with reference to FIG. 2 will not be repeated.

With reference to FIG. 7, the optical compensation structure 700 of the seventh embodiment is similar to the optical compensation structure 200 illustrated in FIG. 2, and the difference therebetween lies in that the optical compensation structure 700 may further include a second coating layer 760. The second coating layer 760 is disposed on the first region R1 of the substrate 110. On the first region R1 of the substrate 110, the second coating parts 252 of the first coating layer 250 contact the barrier layer 240, and the second coating layer 760 contacts the barrier layer 240. For instance, the second coating layer 760 disposed on the first region R1 may include a plurality of bar structures or island structures which are separated from one another, and the second coating parts 252 of the first coating layer 250 may be located between the separated bar structures or island structures.

In the present embodiment, a material and/or a forming method of the second coating layer 760 may be similar to the material and/or the forming method of the first coating layer 250 and thus, will not be repeatedly described. In addition, by adjusting the material compositions and/or the forming methods of the second coating layer 760 and the first coating layer 250, the second coating layer 760 and the first coating layer 250 may be different in hardness, refractive index and/or thickness.

FIG. 8 is a schematic cross-sectional view of an optical compensation structure according to an eighth embodiment of the disclosure. An optical compensation structure 800 of the eighth embodiment is similar to the optical compensation structure 200 illustrated in FIG. 2, description related to the optical compensation structure 800 will be set forth with reference to FIG. 8 in the present embodiment. It should be noted that in FIG. 8, the same or similar reference numbers are used to represent the same or similar elements, and thus, the elements which have been described with reference to FIG. 2 will not be repeated.

With reference to FIG. 8, the optical compensation structure 800 of the eighth embodiment is similar to the optical compensation structure 200 illustrated in FIG. 2, and the difference therebetween lies in that the optical compensation structure 800 may further include an elastic layer 870, wherein the first coating layer 250 is located between the elastic layer 870 and the barrier layer 240, and the elastic layer 870 contacts the first coating layer 250 and a portion of the barrier layer 240 which is not covered by the first coating layer 250. A Young's modulus of the first coating layer 250 is greater than a Young's modulus of the elastic layer 870.

Generally, the elastic layer 870 may be correspondingly extended or compressed when an external force is received by the optical compensation structure 800, such that the optical compensation structure 800 has a corresponding deformed state. In addition, the elastic layer 870 may help to disperse the stress when being extended and compressed, so as to prevent the substrate 110 or the structures on the substrate 110 from being damaged. After the external force disappears, the optical compensation structure 800 is returned to its initial state as the external force is not received.

For instance, a material of the elastic layer 870 may be, for example, a chained hydrocarbon polymer material, such as a rubber adhesive, an acrylic adhesive or a silicone resin adhesive. The rubber adhesive includes natural rubber and synthetic rubber, while acrylic adhesive includes standard acrylic and modified acrylic. A forming method of the elastic layer 870 may include, for example, a coating method, a bonding method, a Sol-Gel method or a lamination method. For instance, a photo-polymerization process or a baking process may be performed on an elastic material, after being formed on the first coating layer 250, to cure the elastic material to form the elastic layer 870. In the present embodiment, a ratio of the Young's modulus of the first coating layer 250 to the Young's modulus of the elastic layer 870 is greater than or equal to 2. In an embodiment, the ratio of the Young's modulus of the first coating layer 250 to the Young's modulus of the elastic layer 870 may be greater than or equal to 10. Alternatively, in an embodiment, the ratio of the Young's modulus of the first coating layer 250 to the Young's modulus of the elastic layer 870 may be greater than or equal to 50. Namely, by being compared with the first coating layer 250, the elastic layer 870, after receiving the force, has a greater plastic deformation degree.

In the present embodiment, the elastic layer 870 has a third surface S3 far away from the substrate 110, and the third surface S3 may be a planar surface, such that other subsequently formed film layers and/or components may be Mimed on the planar third surface S3, but the disclosure is not limited thereto.

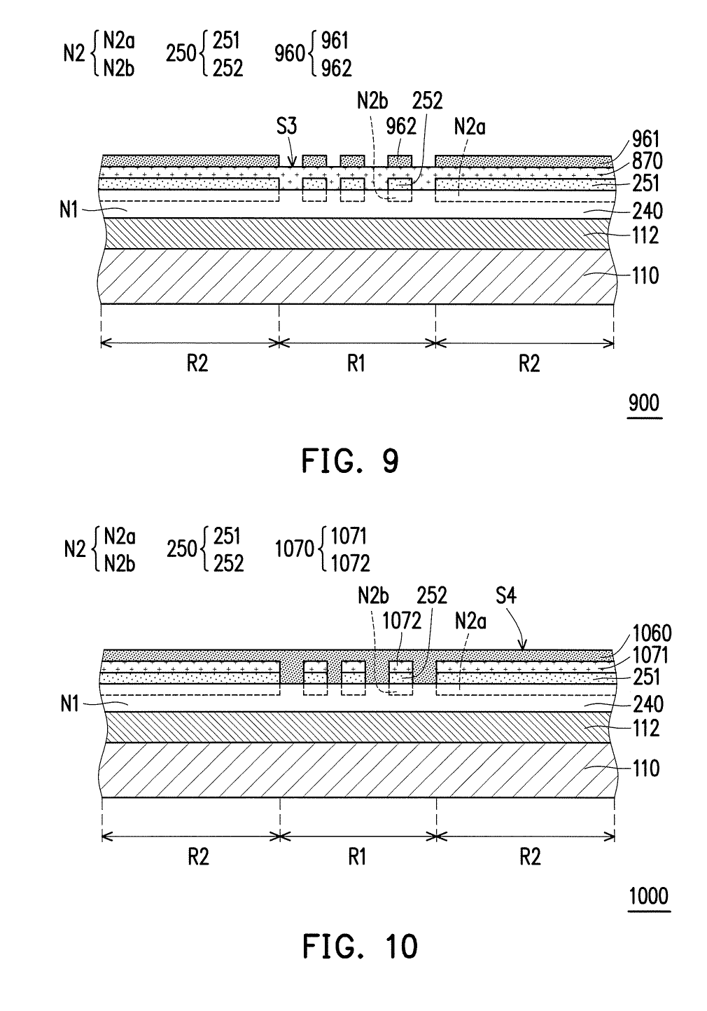

FIG. 9 is a schematic cross-sectional view of an optical compensation structure according to a ninth embodiment of the disclosure. An optical compensation structure 900 of the ninth embodiment is similar to the optical compensation structure 800 illustrated in FIG. 8, and description related to the optical compensation structure 900 will be set forth with reference to FIG. 9 in the present embodiment. It should be noted that in FIG. 9, the same or similar reference numbers are used to represent the same or similar elements, and thus, the elements which have been described with reference to FIG. 8 will not be repeated.

With reference to FIG. 9, the optical compensation structure 900 of the ninth embodiment is similar to the optical compensation structure 800 illustrated in FIG. 8, and the difference therebetween lies in that the optical compensation structure 900 may further include a second coating layer 960, wherein the elastic layer 870 is located between the second coating layer 960 and the first coating layer 250, and the second coating layer 960 contacts the elastic layer 870. The second coating layer 960 includes third coating parts 961 and fourth coating parts 962 which are separated from each other. The third coating parts 961 are disposed corresponding to the first coating parts 251, and the third coating parts 961 are disposed on the second regions R2 of the substrate 110. The fourth coating parts 962 are disposed corresponding to the second coating parts 252, and the fourth coating parts 962 are disposed on the first region R1 of the substrate 110. For instance, the fourth coating parts 962 disposed on the first region R1 may be a plurality of bar structures or island structures which are separated from one another. In this way, the first region R1 may be correspondingly extended or compressed when an external force is received by the optical compensation structure 900, such that the optical compensation structure 900 has a corresponding deformed state. In brief, in the present embodiment, the second coating layer 960 is disposed corresponding to the first coating layer 250, but the disclosure is not limited thereto.

In the present embodiment, a material and/or a forming method of the second coating layer 960 may be similar to the material and/or the forming method of the first coating layer 250 and thus, will not be repeatedly described. In addition, by adjusting the material compositions and/or the forming methods of the second coating layer 960 and the first coating layer 250, the second coating layer 960 and the first coating layer 250 may be different in hardness, refractive index and/or thickness.

FIG. 10 is a schematic cross-sectional view of an optical compensation structure according to a tenth embodiment of the disclosure. An optical compensation structure 1000 of the tenth embodiment is similar to the optical compensation structure 800 illustrated in FIG. 8, and description related to the optical compensation structure 1000 will be set forth with reference to FIG. 10 in the present embodiment. It should be noted that in FIG. 10, the same or similar reference numbers are used to represent the same or similar elements, and thus, the elements which have been described with reference to FIG. 8 will not be repeated.

With reference to FIG. 10, the optical compensation structure 1000 of the tenth embodiment is similar to the optical compensation structure 800 illustrated in FIG. 8, and the difference therebetween lies in that an elastic layer 1070 is disposed corresponding to the first coating layer 250, and the optical compensation structure 1000 may further include a second coating layer 1060, where the elastic layer 1070 is located between the first coating layer 250 and the second coating layer 1060.

The elastic layer 1070 includes first elastic parts 1071 and second elastic parts 1072 which are separated from each other. The first elastic parts 1071 are disposed corresponding to the first coating parts 251, and the first elastic parts 1071 are disposed on the second regions R2 of the substrate 110. The second elastic parts 1072 are disposed corresponding to the second coating parts 252, and the second elastic parts 1072 are disposed on the first region R1 of the substrate 110.

The second coating layer 1060 contacts the elastic layer 1070, and the second coating layer 1060 contacts a portion of the barrier layer 240 which is not covered by the first coating layer 250. In the present embodiment, the second coating layer 1060 has a fourth surface S4 far away from the substrate 110, and the fourth surface S4 may be a planar surface, such that other subsequently formed film layers and/or components may be formed on the planar fourth surface S4, but the disclosure is not limited thereto.

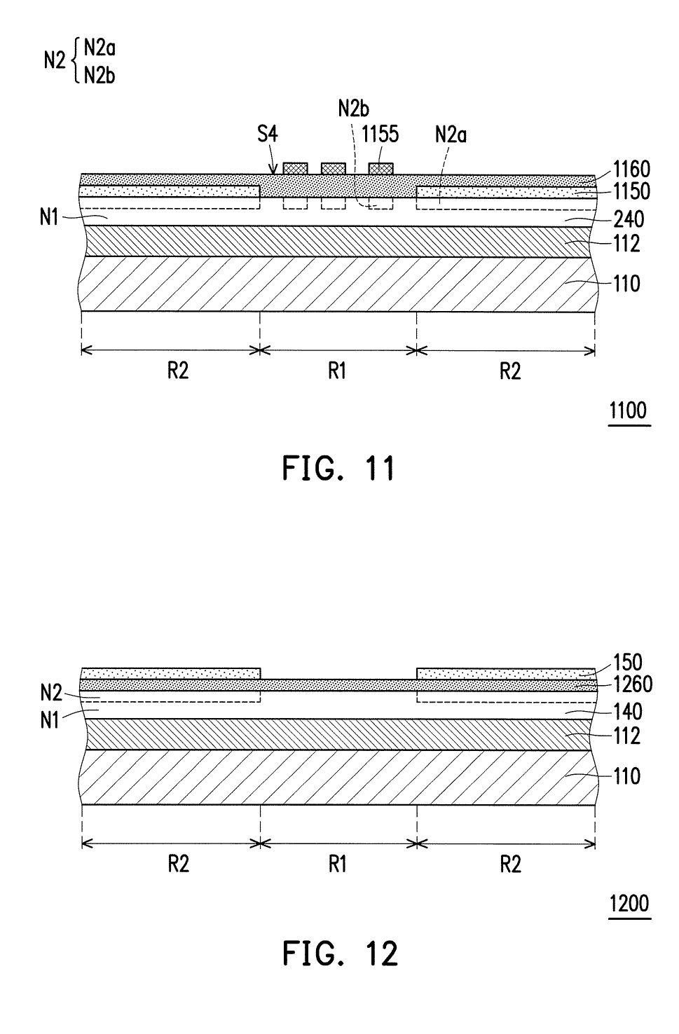

FIG. 11 is a schematic cross-sectional view of an optical compensation structure according to an eleventh embodiment of the disclosure. An optical compensation structure 1100 of the eleventh embodiment is similar to the optical compensation structure 200 illustrated in FIG. 2, and description related to the optical compensation structure 1100 will set forth with reference to FIG. 11 in the present embodiment. It should be noted that in FIG. 11, the same or similar reference numbers are used to represent the same or similar elements, and thus, the elements which have been described with reference to FIG. 2 will not be repeated.

With reference to FIG. 11, the optical compensation structure 1100 of the eleventh embodiment is similar to the optical compensation structure 200 illustrated in FIG. 2, and the difference therebetween lies in that the optical compensation structure 1100 may further include a second coating layer 1160 and third coating layers 1155. First coating layers 1150 are located between the barrier layer 240 and the second coating layer 1160. The second coating layer 1160 is located between the first coating layers 1150 and the third coating layers 1155. The first coating layers 1150 are disposed corresponding to the first refraction parts N2a, and the first coating layers 1150 are disposed on the second regions R2 of the substrate 110. The third coating layers 1155 are disposed corresponding to the second refraction parts N2b, and the third coating layers 1155 are disposed on the first region R1 of the substrate 110.

The second coating layer 1160 contacts the first coating layers 1150, and the second coating layer 1160 contacts a portion of the barrier layer 240 which is not covered by the first coating layers 1150. In the present embodiment, the second coating layer 1160 has a fourth surface S4 far away from the substrate 110, and the fourth surface S4 may be a planar surface, such that the subsequently formed third coating layers 1155, other film layers and/or components may be formed on the planar fourth surface S4, but the disclosure is not limited thereto.

The third coating layers 1155 are located on the fourth surface S4 of the second coating layer 1160, thereby contacting the second coating layer 1160, and the first coating layers 1150 do not overlap the third coating layers 1155. In the present embodiment, the third coating layers 1155 disposed on the first region R1 may be a plurality of bar structures or island structures which are separated from one another, but the disclosure is not limited thereto.

In the present embodiment, materials and/or forming methods of the first coating layers 1150, the second coating layer 1160 and/or third coating layers 1155 may be similar to the material and/or the forming method of the first coating layers of the embodiments described above (e.g., the first coating layer 250 in the second embodiment) and thus, will not be repeatedly described. In addition, by adjusting the material compositions and/or the forming methods of the first coating layers 1150, the second coating layer 1160 and/or the third coating layers 1155, the first coating layers 1150, the second coating layer 1160 and/or the third coating layers 1155 may be different in hardness, refractive index and/or thickness.

FIG. 12 is a schematic cross-sectional view of an optical compensation structure according to a twelfth embodiment of the disclosure. An optical compensation structure 1200 of the twelfth embodiment is similar to the optical compensation structure 100 illustrated in FIG. 1, and description related to the optical compensation structure 1200 will be set forth with reference to FIG. 12 in the present embodiment. It should be noted that in FIG. 12, the same or similar reference numbers are used to represent the same or similar elements, and thus, the elements which have been described with reference to FIG. 1 will not be repeated.

With reference to FIG. 12, the optical compensation structure 1200 of the twelfth embodiment is similar to the optical compensation structure 100 illustrated in FIG. 1, and the difference therebetween lies in that the optical compensation structure 1200 may further include a second coating layer 1260, wherein the second coating layer 1260 is located between the first coating layer 150 and the barrier layer 140. The second coating layer 1260 is disposed on the first region R1 and the second regions R2 of the substrate 110, and two opposite sides of the second coating layer 1260 respectively contact the barrier layer 140 and the first coating layer 150.

In the present embodiment, a material and/or a forming method of the second coating layer 1260 may be similar to the material and/or the forming method of the first coating layer 150 and thus, will not be repeatedly described. In addition, by adjusting the material compositions and/or the forming methods of the second coating layer 1260 and the first coating layer 150, the second coating layer 1260 and the first coating layer 150 may be different in hardness, refractive index and/or thickness.

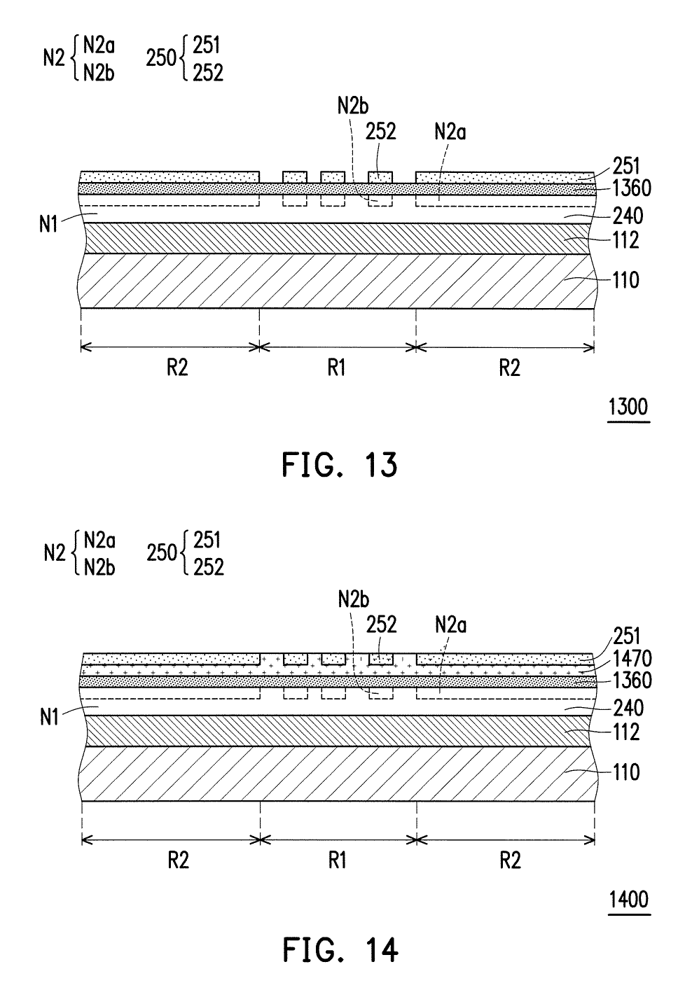

FIG. 13 is a schematic cross-sectional view of an optical compensation structure according to a thirteenth embodiment of the disclosure. An optical compensation structure 1300 of the thirteenth embodiment is similar to the optical compensation structure 200 illustrated in FIG. 2, and description related to the optical compensation structure 1300 will be set forth with reference to FIG. 13 in the present embodiment. It should be noted that in FIG. 13, the same or similar reference numbers are used to represent the same or similar elements, and thus, the elements which have been described with reference to FIG. 2 will not be repeated.

With reference to FIG. 13, the optical compensation structure 1300 of the thirteenth embodiment is similar to the optical compensation structure 200 illustrated in FIG. 2, and the difference therebetween lies in that the optical compensation structure 1300 may further include a second coating layer 1360, wherein the second coating layer 1360 is located between the first coating layer 250 and the barrier layer 240. The second coating layer 1360 is disposed on the first region R1 and the second regions R2 of the substrate 110, and two opposite sides of the second coating layer 1360 respectively contact the barrier layer 240 and the first coating layer 250.

In the present embodiment, a material and/or a forming method of the second coating layer 1360 may be similar to the material and/or the Raining method of the first coating layer 250 and thus, will not be repeatedly described. In addition, by adjusting the material compositions and/or the forming methods of the second coating layer 1360 and the first coating layer 250, the second coating layer 1360 and the first coating layer 250 may be different in hardness, refractive index and/or thickness.

FIG. 14 is a schematic cross-sectional view of an optical compensation structure according to a fourteenth embodiment of the disclosure. An optical compensation structure 1400 of the fourteenth embodiment is similar to the optical compensation structure 1300 illustrated in FIG. 13, and description related to the optical compensation structure 1400 will be set forth with reference to FIG. 14 in the present embodiment. It should be noted that in FIG. 14, the same or similar reference numbers are used to represent the same or similar elements, and thus, the elements which have been described with reference to FIG. 13 will not be repeated.

With reference to FIG. 14, the optical compensation structure 1400 of the fourteenth embodiment is similar to the optical compensation structure 1300 illustrated in FIG. 13, and the difference therebetween lies in that the optical compensation structure 1400 may further include an elastic layer 1470, wherein the elastic layer 1470 is located between the first coating layer 250 and the second coating layer 1360 and the elastic layer 1470 disposed on the first region R1 is located between the separated bar structures or island structures of the second coating parts 252. The Young's modulus of the first coating layer 250 is greater than a Young's modulus of the elastic layer 1470, and a Young's modulus of the second coating layer 1360 is greater than the Young's modulus of the elastic layer 1470.

In the present embodiment, a material and/or a forming method of the elastic layer 1470 may be similar to the material and/or the forming method of the elastic layer in any one of the embodiment above (e.g., the elastic layer 870 in the eighth embodiment) and thus, will not be repeatedly described.

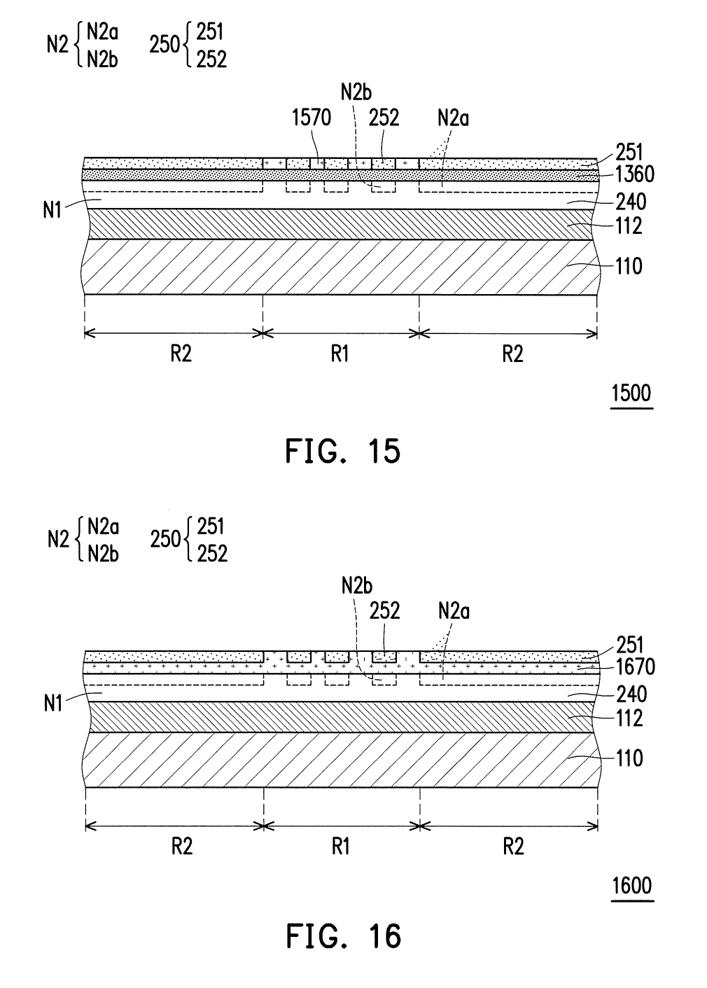

FIG. 15 is a schematic cross-sectional view of an optical compensation structure according to a fifteenth embodiment of the disclosure. An optical compensation structure 1500 of the fifteenth embodiment is similar to the optical compensation structure 1300 illustrated in FIG. 13, and description related to the optical compensation structure 1500 will be set forth with reference to FIG. 15 in the present embodiment. It should be noted that in FIG. 15, the same or similar reference numbers are used to represent the same or similar elements, and thus, the elements which have been described with reference to FIG. 13 will not be repeated.

With reference to FIG. 15, the optical compensation structure 1500 of the fifteenth embodiment is similar to the optical compensation structure 1300 illustrated in FIG. 13, and the difference therebetween lies in that the optical compensation structure 1500 may further include an elastic layer 1570, wherein the elastic layer 1570 is disposed on the first region R1, and the elastic layer 1570 is located between the separated bar structures or island structures of the second coating parts 252. The Young's modulus of the first coating layer 250 is greater than the Young's modulus of the elastic layer 1570, and the Young's modulus of the second coating layer 1360 is greater than the Young's modulus of the elastic layer 1570.

In the present embodiment, a material and/or a forming method of the elastic layer 1570 may be similar to the material and/or the forming method of the elastic layers of the embodiments described above (e.g., the elastic layer 870 in the eighth embodiment) and thus, will not be repeatedly described.

FIG. 16 is a schematic cross-sectional view of an optical compensation structure according to a sixteenth embodiment of the disclosure. An optical compensation structure 1600 of the sixteenth embodiment is similar to the optical compensation structure 200 illustrated in FIG. 2, and description related to the optical compensation structure 1600 will be set forth with reference to FIG. 16 in the present embodiment. It should be noted that in FIG. 16, the same or similar reference numbers are used to represent the same or similar elements, and thus, the elements which have been described with reference to FIG. 2 will not be repeated.

With reference to FIG. 16, the optical compensation structure 1600 of the sixteenth embodiment is similar to the optical compensation structure 200 illustrated in FIG. 2, and the difference therebetween lies in that the optical compensation structure 1600 may further include an elastic layer 1670, wherein the elastic layer 1670 is located between the first coating layer 250 and the barrier layer 240, and two opposite sides of the elastic layer 1670 respectively contact the barrier layer 240 and the first coating layer 250. In addition, the elastic layer 1670 disposed on the first region R1 is further located between the separated bar structures or island structures of the second coating parts 252.

In the present embodiment, a material and/or a forming method of the elastic layer 1670 may be similar to the material and/or the forming method of the elastic layers of the embodiments described above (e.g., the elastic layer 870 in the eighth embodiment) and thus, will not be repeatedly described.

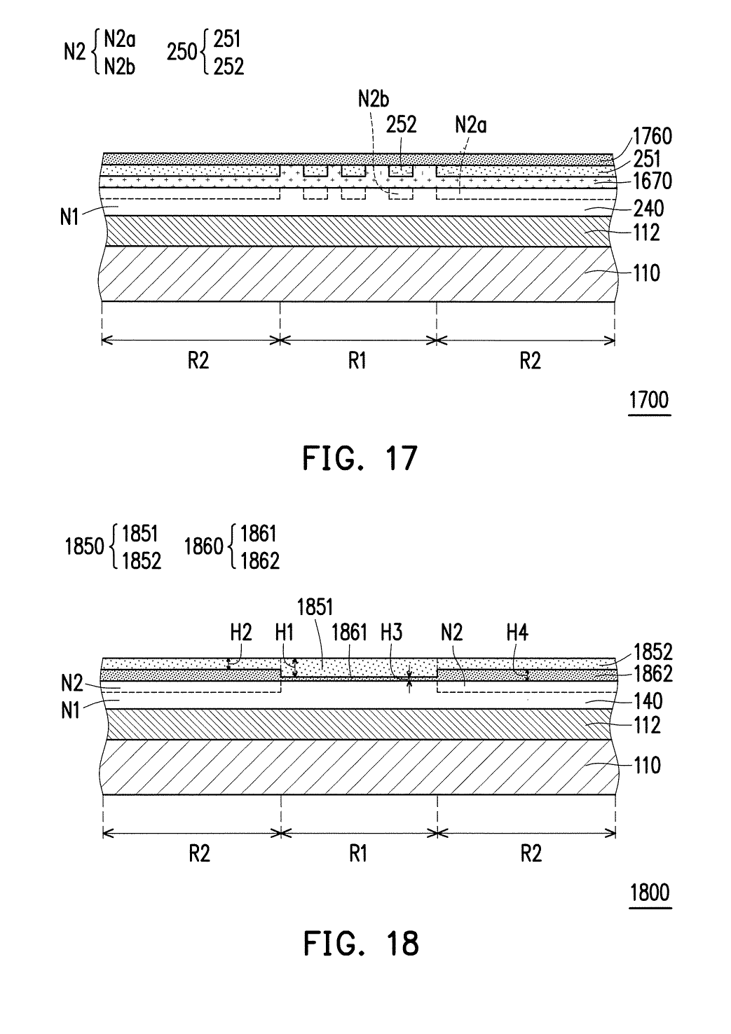

FIG. 17 is a schematic cross-sectional view of an optical compensation structure according to a seventeenth embodiment of the disclosure. An optical compensation structure 1700 of the seventh embodiment is similar to the compensation structure 1600 illustrated in FIG. 16, and description related to the optical compensation structure 1700 will be set forth with reference to FIG. 17 in the present embodiment. It should be noted that in FIG. 17, the same or similar reference numbers are used to represent the same or similar elements, and thus, the elements which have been described with reference to FIG. 16 will not be repeated.

With reference to FIG. 17, the optical compensation structure 1700 of the seventh embodiment is similar to the compensation structure 1600 illustrated in FIG. 16, and the difference therebetween lies in that the optical compensation structure 1700 may further include a second coating layer 1760, wherein the first coating layer 250 is located between the elastic layer 1670 and the second coating layer 1760. The second coating layer 1760 is located on the first coating layer 250, and the second coating layer 1760 contacts the first coating layer 250 and the elastic layer 1670 disposed on the first region R1.

In the present embodiment, a material and/or a forming method of the second coating layer 1760 may be similar to the material and/or the forming method of the first coating layer 250 and thus, will not be repeatedly described. In addition, by adjusting the material compositions and/or the forming methods of the second coating layer 1760 and the first coating layer 250, the second coating layer 1760 and the first coating layer 250 may be different in hardness, refractive index and/or thickness.

FIG. 18 is a schematic cross-sectional view of an optical compensation structure according to an eighteenth embodiment of the disclosure. An optical compensation structure 1800 of the eighteenth embodiment is similar to the optical compensation structure 100 illustrated in FIG. 1, and description related to the optical compensation structure 1800 will be set forth with reference to FIG. 18 in the present embodiment. It should be noted that in FIG. 18, the same or similar reference numbers are used to represent the same or similar elements, and thus, the elements which have been described with reference to FIG. 1 will not be repeated.

With reference to FIG. 18, the optical compensation structure 1800 of the eighteenth embodiment is similar to the optical compensation structure 100 illustrated in FIG. 1, and the difference therebetween lies in that a first coating layer 1850 has a first coating part 1851 and second coating parts 1852 adjacent to the first coating part 1851, wherein the first coating part 1851 covers a region other than the second refractive regions N2 of the barrier layer 140, the second coating parts 1852 cover the second refractive regions N2 of the barrier layer 140. The first coating part 1851 has a first coating thickness H1, the second coating parts 1852 have a second coating thickness H2, and the first coating thickness H1 is greater than the second coating thickness H2. The second coating layer 1860 is located between the first coating layer 1850 and the barrier layer 140, and two opposite sides of the second coating layer 1860 respectively contact the barrier layer 140 and the first coating layer 1850.

In the present embodiment, the second coating layer 1860 has a third coating part 1861 and fourth coating parts 1862 adjacent to the third coating part 1861, where the third coating part 1861 covers a region other than the second refractive regions N2 of the barrier layer 140, and the fourth coating parts 1862 cover the second refractive regions N2 of the barrier layer 140, but the disclosure is not limited thereto. The third coating part 1861 has a third coating thickness H3, the fourth coating part 1862 has a fourth coating thickness H4, and the third coating thickness H3 is less than the fourth coating thickness H4.

In the present embodiment, a material and/or a forming method of the first coating layer 1850 may be similar to the material and/or the forming method of the first coating layers of the embodiments described above (e.g., the first coating layer 150 in the first embodiment). A material and/or a forming method of the second coating layer 1860 may be similar to the material and/or the forming method of the first coating layer 1850 and thus, will not be repeatedly described. In addition, by adjusting the material compositions and/or the forming methods of the second coating layer 1860 and the first coating layer 1850, the second coating layer 1860 and the first coating layer 1850 may be different in hardness, refractive index and/or thickness.

For instance, the first coating layer 1850 and/or the second coating layer 1860 having inconsistent thicknesses may be formed by performing a coating process and a photo-curing/thermal curing process for several times, which is not limited in the disclosure.

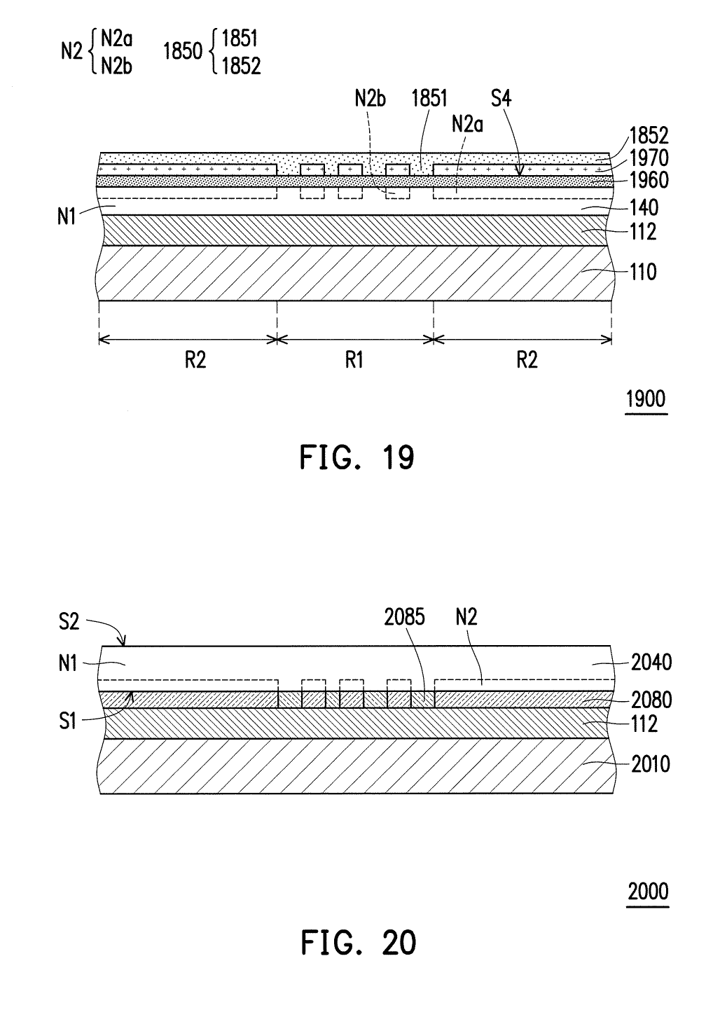

FIG. 19 is a schematic cross-sectional view of an optical compensation structure according to a nineteenth embodiment of the disclosure. An optical compensation structure 1900 of the nineteenth embodiment is similar to the optical compensation structure 1800 illustrated in FIG. 18, and description related to the optical compensation structure 1900 will be set forth with reference to FIG. 19 in the present embodiment. It should be noted that in FIG. 19, the same or similar reference numbers are used to represent the same or similar elements, and thus, the elements which have been described with reference to FIG. 18 will not be repeated.

With reference to FIG. 19, the optical compensation structure 1900 of the nineteenth embodiment is similar to the optical compensation structure 1800 illustrated in FIG. 18, and the difference therebetween lies in that the optical compensation structure 1900 may further include an elastic layer 1970. The elastic layer 1970 is located between the first coating layer 1850 and the second coating layer 1960, and the elastic layer 1970 covers the second refractive regions N2 of the barrier layer 140.

In the present embodiment, a material and/or a forming method of the second coating layer 1960 may be similar to the material and/or the forming method of the second coating layers of the embodiments described above (e.g., the second coating layer 1360 in the thirteenth embodiment) and thus, will not be repeatedly described.

In the present embodiment, a material and/or a forming method of the elastic layer 1970 may be similar to the material and/or the forming method of the elastic layers of the embodiments described above (e.g., the elastic layer 870 in the eighth embodiment) and thus, will not be repeatedly described.

In the present embodiment, the second coating layer 1960 has a fourth surface S4 far away from the substrate 110, and the fourth surface S4 may be a planar surface, such that the subsequently formed elastic layer 1970, other film layers and/or components may be formed on the planar fourth surface S4, but the disclosure is not limited thereto.

FIG. 20 is a schematic cross-sectional view of an optical compensation structure according to a twentieth embodiment of the disclosure. With reference to FIG. 20, an optical compensation structure 2000 of the present embodiment includes a substrate 2010, a barrier layer 2040, first adhesive layers 2080 and second adhesive layers 2085. The barrier layer 2040 has a first refractive region N1 and second refractive regions N2 adjacent thereto. A refractive index of the second refractive regions N2 is greater than a refractive index of the first refractive region N1. The first adhesive layers 2080 are located between the barrier layer 2040 and the substrate 2010 and cover the second refractive regions N2 of the barrier layer 2040. The second adhesive layers 2085 are located between the barrier layer 2040 and the substrate 2010, and the second adhesive layers 2085 do not overlap the second refractive regions N2 of the barrier layer 2040.

In the present embodiment, the optical compensation structure 2000 may further include an electronic component layer 112. The electronic component layer 112 is located between the barrier layer 2040 and the substrate 2010.

In the present embodiment, the substrate 2010 may be a rigid substrate or a flexible substrate. For instance, a material of the rigid substrate may include, for example, glass, quartz, a metal or other hard materials, a material of the flexible substrate may be similar to a material or a substance of the substrates of the embodiments described above (e.g., the substrate 110 in the first embodiment), and thus, they will not be repeatedly described.

In the present embodiment, a material of the first adhesive layers 2080 and/or the second adhesive layers 2085 may be an optically clear adhesive, a viscose or a solid tape, but the disclosure is not limited thereto. In this way, the barrier layer 2040 may contact and be adhered and fastened to the first adhesive layers 2080 and/or the second adhesive layer 2085. For instance, the barrier layer 2040 having the first refractive region N1 and the second refractive regions N2 may be adhered onto the substrate 2010 or the substrate 2010 having the electronic component layer 112 through the first adhesive layers 2080 and/or second adhesive layers 2085.

The barrier layer 2040 has a first surface S1 and a second surface S2 which are opposite to each other. The second refractive regions N2 of the barrier layer 2040 extend inward from the first surface S1, and the second surface S2 and a portion of the first surface S1 are located on the first refractive region N1. The barrier layer 2040 covers the electronic component layer 112, and the first surface S1 of the barrier layer 2040 contacts the first adhesive layers 2080 and/or the second adhesive layers 2085.

In the present embodiment, a material and/or a forming method of the barrier layer 2040 may be similar to the material and/or the forming method of the barrier layers of the embodiments described above (e.g., the barrier layer 140 in the first embodiment) and thus, will not be repeatedly described.

In the present embodiment, the first adhesive layers 2080 and the second adhesive layers 2085 are patterned film layers. The second refractive regions N2 of the barrier layer 2040 are distributed corresponding the first adhesive layers 2080, and regions other than the second refractive regions N2 of the barrier layer 2040 are distributed corresponding to the second adhesive layers 2085. A refractive index of the first adhesive layer 2080 is less than a refractive index of the second adhesive layer 2085. In this way, with the barrier layer 2040 having the first refractive region N1 and the second refractive regions N2, the optical disparity issue may be prevented from occurring to the patterned first adhesive layers 2080 and second adhesive layers 2085.

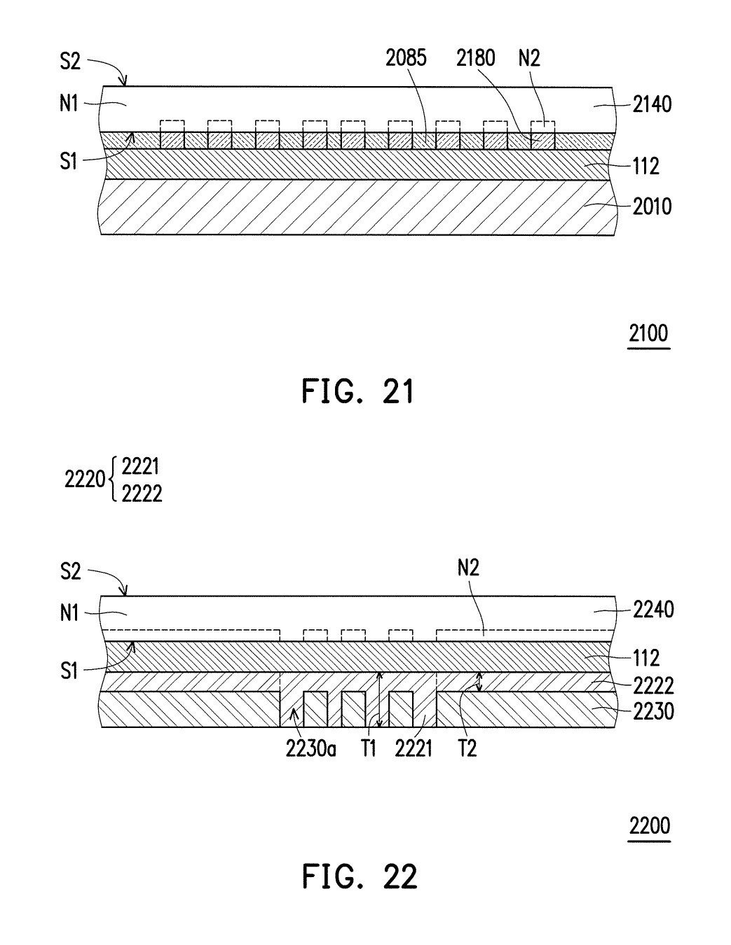

FIG. 21 is a schematic cross-sectional view of an optical compensation structure according to a twenty-first embodiment of the disclosure. An optical compensation structure 2100 of the twenty-first embodiment is similar to the optical compensation structure 2000 illustrated in FIG. 20, and description related to the optical compensation structure 2100 will be set forth with reference to FIG. 21 in the present embodiment. It should be noted that in FIG. 21, the same or similar reference numbers are used to represent the same or similar elements, and thus, the elements which have been described with reference to FIG. 20 will not be repeated.

With reference to FIG. 21, the optical compensation structure 2100 of the twenty-first embodiment is similar to the optical compensation structure 2000 illustrated in FIG. 20, and the difference therebetween lies in that the second refractive regions N2 of the barrier layer 2140 may be arranged in a grid, lattice or mesh shape. Namely, the first adhesive layers 2180 covering the second refractive regions N2 of the barrier layer 2140 may also be arranged corresponding to the second refractive regions N2 in a grid, lattice or mesh shape.

FIG. 22 is a schematic cross-sectional view of an optical compensation structure according to a twenty-second embodiment of the disclosure. With reference to FIG. 22, an optical compensation structure 2200 of the present embodiment includes a first substrate 2220, a barrier layer 2240 and a second substrate 2230. The first substrate 2220 has first substrate parts 2221 and second substrate parts 2222 adjacent thereto. The first substrate parts 2221 have a first substrate thickness T1, the second substrate parts 2222 have a second substrate thickness T2, and the first substrate thickness T1 is greater than the second substrate thickness T2. The barrier layer 2240 is located above the first substrate 2220. The barrier layer 2240 has a first refractive region N1 and second refractive regions N2 adjacent thereto. A refractive index of the second refractive regions N2 is greater than a refractive index of the first refractive region N1. The second refractive regions N2 of the barrier layer 2240 are distributed corresponding to the second substrate parts 2222 of the first substrate 2220. The first substrate 2220 is located between the barrier layer 2240 and the second substrate 2230. A Young's modulus of the second substrate 2230 is greater than a Young's modulus of the first substrate 2220.

In the present embodiment, the optical compensation structure 2200 may further include an electronic component layer 112. The electronic component layer 112 is located between the barrier layer 2240 and the first substrate 2220.

In the present embodiment, a material of the first substrate 2220 may be similar to the material of the substrates of the embodiments described above (e.g., the substrate 110 in the first embodiment) and thus, will not be repeatedly described.

In the present embodiment, the second substrate 2230 may be a rigid substrate or a flexible substrate. For instance, a material of the aforementioned rigid substrate may include, for example, glass, quartz, a metal or other hard materials, and a material of the aforementioned flexible substrate may be similar to the material of the first substrate 2220, but the disclosure is not limited thereto.

In the present embodiment, the second substrate 2230 may be a patterned substrate having substrate openings 2230a, and the substrate openings 2230a may be linear, bent or curved trenches or slits, such that the optical compensation structure 2200 may be stretched, compressed or curved as the corresponding substrate openings 2230a are deformed. The substrate opening 2230a are formed in the second substrate 2230 by means of, for example, etching, cutting or computer numerical control (CNC) punching, but the disclosure is not limited thereto.

The barrier layer 2240 has a first surface S1 and a second surface S2 opposite to each other. The second refractive regions N2 of the barrier layer 2240 extends inward from the first surface S1, and the second surface S2 and a portion of the first surface S1 are located in the first refractive region N1.

In the present embodiment, the barrier layer 2240 covers the electronic component layer 112, and the first surface S1 of the barrier layer 2240 contacts the electronic component layer 112, but the disclosure is not limited thereto. In other embodiments, other film layers may be included between the barrier layer 2240 and the electronic component layer 112.

In the present embodiment, a material and/or a forming method of the barrier layer 2240 may be similar to the material and/or the forming method of the barrier layers of the embodiments described above (e.g., the barrier layer 140 in the first embodiment) and thus, will not be repeatedly described.

In the present embodiment, the first substrate 2220 and the second substrate 2230 are patterned substrates. The second refractive regions N2 of the barrier layer 2240, the second substrate parts 2222 of the first substrate 2220 and the second substrate 2230 are disposed corresponding to one another. A refractive index of the first substrate 2220 is greater than a refractive index of the second substrate 2230. In this way, with the barrier layer 2240 having the first refractive region N1 and the second refractive regions N2, the optical disparity issue may be prevented from occurring to the patterned first substrate 2220 and second substrate 2230.

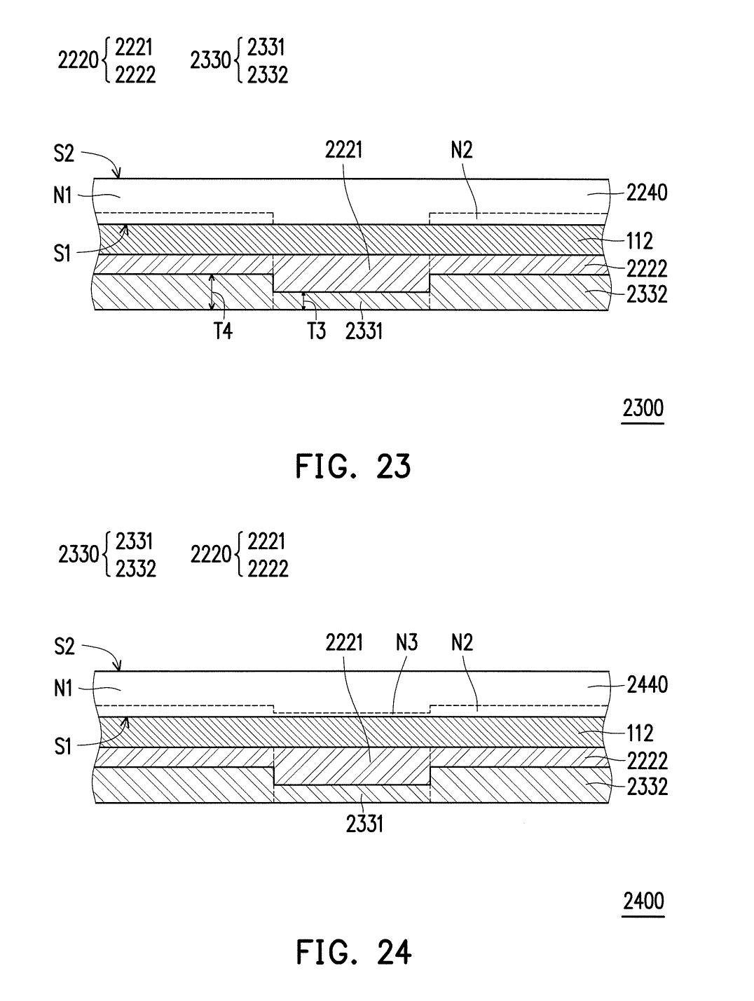

FIG. 23 is a schematic cross-sectional view of an optical compensation structure according to a twenty-third embodiment of the disclosure. An optical compensation structure 2300 of the twenty-third embodiment is similar to the optical compensation structure 2200 illustrated in FIG. 22, and description related to the optical compensation structure 2300 will be set forth with reference to FIG. 23 in the present embodiment. It should be noted that in FIG. 23, the same or similar reference numbers are used to represent the same or similar elements, and thus, the elements which have been described with reference to FIG. 22 will not be repeated.

With reference to FIG. 23, the optical compensation structure 2300 of the twenty-third embodiment is similar to the optical compensation structure 2200 illustrated in FIG. 22, and the difference therebetween lies in that the second substrate 2330 has a third substrate part 2331 and fourth substrate parts 2332 adjacent thereto. The third substrate part 2331 has a third substrate thickness T3, the fourth substrate parts 2332 have a fourth substrate thickness T4, and the third substrate thickness T3 is less than the fourth substrate thickness T4. The first substrate parts 2221 of the first substrate 2220 overlap the third substrate part 2331 of the second substrate 2330. The second substrate parts 2222 of the first substrate 2220 overlap the fourth substrate parts 2332 of the second substrate 2330.

FIG. 24 is a schematic cross-sectional view of an optical compensation structure according to a twenty-fourth embodiment of the disclosure. An optical compensation structure 2400 of the twenty-fourth embodiment is similar to the optical compensation structure 2300 illustrated in FIG. 23, description related to the optical compensation structure 2400 will be set forth with reference to FIG. 24 in the present embodiment. It should be noted that in FIG. 24, the same or similar reference numbers are used to represent the same or similar elements, and thus, the elements which have been described with reference to FIG. 23 will not be repeated.

With reference to FIG. 24, the optical compensation structure 2400 of the twenty-fourth embodiment is similar to the optical compensation structure 2300 illustrated in FIG. 23, and the difference therebetween lies in that the barrier layer 2440 further includes a third refractive region N3 adjacent to the first refractive region N1 and the second refractive regions N2. The third refractive region N3 extends inward from the first surface S1 of the barrier layer 2440. A refractive index of the third refractive region N3 is greater than the refractive index of the first refractive region N1. In the barrier layer 2440, a depth of the third refractive region N3 is less than a depth of the second refractive regions N2. The second refractive region N2 of the barrier layer 2440, the second substrate parts 2222 of the first substrate 2220 and the fourth substrate parts 2332 of the second substrate 2330 are disposed corresponding to one another. The third refractive region N3 of the barrier layer 2440, the first substrate parts 2221 of the first substrate 2220 and the third substrate part 2331 of the second substrate 2330 are disposed corresponding to each other.

In the present embodiment, the second refractive regions N2 and the third refractive region N3 may be formed in the barrier layer 2440 in the similar manner. Generally, the refractive indices or the depths of the second refractive regions N2 and/or the third refractive region N3 may be adjusted by adjusting different process recipes (e.g., an implantation time, a carrier gas type, a carrier gas flow, a carrier gas pressure and/or a voltage pulse) of the PIII process, such that the refractive index of the depth of the second refractive regions N2 may be different from the refractive index of the depth of the third refractive region N3.

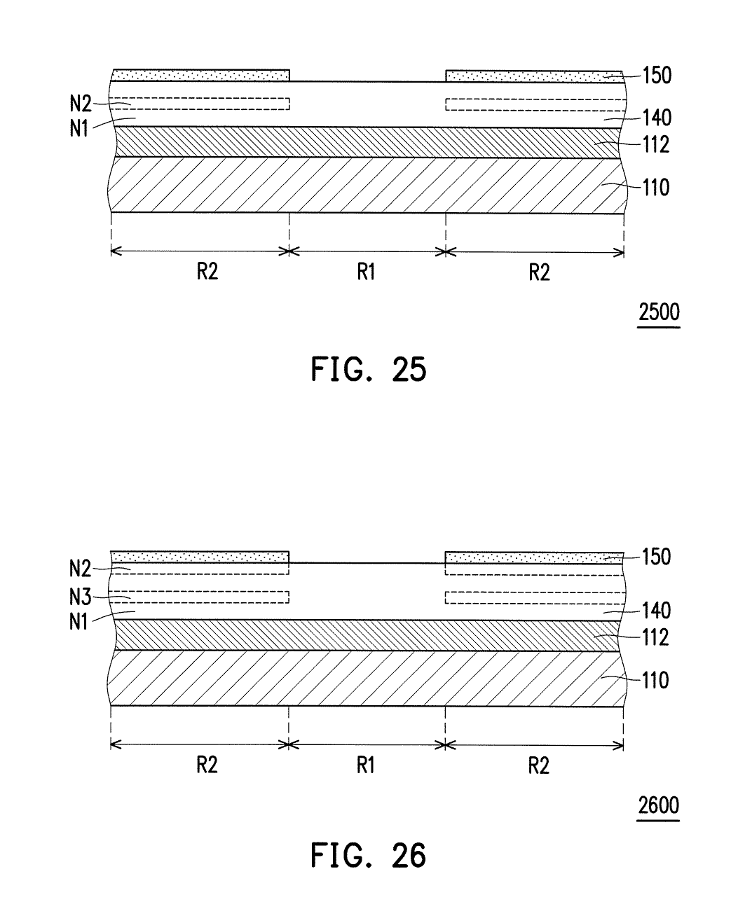

FIG. 25 is a schematic cross-sectional view of an optical compensation structure according to a twenty-fifth embodiment of the disclosure. An optical compensation structure 2500 of the twenty-fifth embodiment is similar to the optical compensation structure 100 illustrated in FIG. 1, and description related to the optical compensation structure 2500 will be set forth with reference to FIG. 25 in the present embodiment. It should be noted that in FIG. 25, the same or similar reference numbers are used to represent the same or similar elements, and thus, the elements which have been described with reference to FIG. 1 will not be repeated.

With reference to FIG. 25, the optical compensation structure 2500 of the twenty-fifth embodiment is similar to the optical compensation structure 100 illustrated in FIG. 1, and the difference therebetween lies in that the second refractive regions N2 are embedded in the first refractive region N1.

Generally, the second refractive region N2 may be embedded in the first refractive region N1 by performing a coating process and/or a surface treatment process for several times, but the disclosure is not limited thereto.

FIG. 26 is a schematic cross-sectional view of an optical compensation structure according to a twenty-sixth embodiment of the disclosure. An optical compensation structure 2600 of the twenty-sixth embodiment is similar to the optical compensation structure 100 illustrated in FIG. 1, and description related to the optical compensation structure 2600 will be set forth with reference to FIG. 26 in the present embodiment. It should be noted that in FIG. 26, the same or similar reference numbers are used to represent the same or similar elements, and thus, the elements which have been described with reference to FIG. 1 will not be repeated.

With reference to FIG. 26, the optical compensation structure 2600 of the twenty-sixth embodiment is similar to the optical compensation structure 100 illustrated in FIG. 1, and the difference therebetween lies in that the barrier layer 140 further includes third refractive regions N3 adjacent to the first refractive region N1, wherein a refractive index of the third refractive regions N3 is greater than the refractive index of the first refractive region N1, and the third refractive regions N3 are embedded in the first refractive region N1.

In the present embodiment, the second refractive regions N2 and the third refractive regions N3 may be formed in the barrier layer 140 in the similar manner. Generally, the refractive index or the depth of the third refractive regions N3 may be adjusted by adjusting different process recipes (e.g., an implantation time, a carrier gas type, a carrier gas flow, a carrier gas pressure and/or a voltage pulse) of the PIII process. Additionally, the third refractive regions N3 may be embedded in the first refractive region N1 by performing a coating process and/or a surface treatment process for several times, but the disclosure is not limited thereto.

In light of the foregoing, the bather layer included in the optical compensation structure introduced by the embodiments of the disclosure at least has the first refractive region and the second refractive region for optically compensating the patterned substrate, the coating layers and/or the adhesive layers, so as to improve the optical disparity issue.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical compensation structure, comprising:
a substrate;
a barrier layer, located on the substrate, wherein the barrier layer has a first refractive region and a second refractive region adjacent to the first refractive region, and a refractive index of the second refractive region is greater than a refractive index of the first refractive region; and
a first coating layer, covering a portion of the second refractive region.

2. The optical compensation structure according to claim 1, wherein the first coating layer contacts a portion of the barrier layer.

3. The optical compensation structure according to claim 2, further comprising a second coating layer, wherein the first coating layer is located between the second coating layer and the barrier layer.

4. The optical compensation structure according to claim 3, wherein the second coating layer contacts the first coating layer.

5. The optical compensation structure according to claim 4, further comprising a third coating layer covering a portion of the second refractive region of the barrier layer, wherein the first coating layer and the third coating layer are located on opposite sides of the second coating layer, and the third coating layer does not overlap the first coating layer.

6. The optical compensation structure according to claim 2, further comprising a second coating layer, wherein the second coating layer contacts the other portion of the barrier layer which is not covered by the first coating layer.

7. The optical compensation structure according to claim 2, further comprising an elastic layer, wherein the elastic layer contacts the first coating layer, and a Young's modulus of the first coating layer is greater than a Young's modulus of the elastic layer.

8. The optical compensation structure according to claim 7, wherein the elastic layer further contacts the other portion of the barrier layer which is not covered by the first coating layer.

9. The optical compensation structure according to claim 7, further comprising a second coating layer, wherein the second coating layer contacts the elastic layer.

10. The optical compensation structure according to claim 1, further comprising a second coating layer, wherein the second coating layer is located between the first coating layer and the barrier layer, and the second coating layer contacts the barrier layer.

11. The optical compensation structure according to claim 10, further comprising an elastic layer, wherein a Young's modulus of the first coating layer is greater than a Young's modulus of the elastic layer, the first coating layer contacts a portion of the second coating layer, and the elastic layer contacts the other portion of the second coating layer which is not covered by the first coating layer.

12. The optical compensation structure according to claim 1, further comprising an elastic layer, wherein a Young's modulus of the first coating layer is greater than a Young's modulus of the elastic layer, the elastic layer is located between the first coating layer and the barrier layer, and the first coating layer contacts the elastic layer.

13. The optical compensation structure according to claim 1, wherein the barrier layer has a first surface and a second surface opposite to each other, the second refractive region extends inward from the first surface, and the second surface and a portion of the first surface are located in the first refractive region.

14. The optical compensation structure according to claim 1, wherein the barrier layer further has a third refractive region embedded in the first refractive region, a refractive index of the third refractive region is greater than the refractive index of the first refractive region, and the third refractive region overlaps the second refractive region.

15. The optical compensation structure according to claim 1, wherein the substrate has first regions and second regions which are adjacent to each other, a flexibility of the first regions is greater than a flexibility of the second regions, and a portion of the first coating layer disposed corresponding to the first regions has a plurality of bar structures or island structures which are separated from one other.

16. The optical compensation structure according to claim 1, further comprising an electronic component layer located between the barrier layer and the substrate.

17. An optical compensation structure, comprising:
a substrate;
a barrier layer, located on the substrate, wherein the barrier layer has a first refractive region and a second refractive region adjacent to the first refractive region, and a refractive index of the second refractive region is greater than a refractive index of the first refractive region; and
a first coating layer, having a first coating part and a second coating part adjacent to the first coating part, wherein the first coating part covers a region other than the second refractive region, the second coating part covers the second refractive region, and a thickness of the first coating part is greater than a thickness of the second coating part; and
a second coating layer, located between the first coating layer and the barrier layer and contacting the barrier layer.

18. The optical compensation structure according to claim 17, wherein the second coating layer has a third coating part and a fourth coating part adjacent to the third coating part, wherein the third coating part covers a region other than the second refractive region, the fourth coating part covers the second refractive region, and a thickness of the third coating part is less than a thickness of the fourth coating part.

19. The optical compensation structure according to claim 17, further comprising an elastic layer, wherein the elastic layer covers the second refractive region.

20. An optical compensation structure, comprising:
a substrate;
a barrier layer, having a first refractive region and a second refractive region adjacent to the first refractive region, wherein a refractive index of the second refractive region is greater than a refractive index of the first refractive region;
a first adhesive layer, located between the barrier layer and the substrate, wherein the second refractive region is distributed corresponding to the first adhesive layer; and
a second adhesive layer, located between the barrier layer and the substrate, wherein the first adhesive layer does not overlap the second adhesive layer.
